(19) United States
(12) Patent Application Publication
(10) Pub. No.: US 2015/0164009 A1
(43) Pub. Date: Jun. 18, 2015

(54) SYSTEM AND METHOD FOR GARDEN MONITORING AND MANAGEMENT

(71) Applicants: Robert Bosch Tool Corporation, Broadview, IL (US); Robert Bosch GmbH, Stuttgart (DE)

(72) Inventors: Anand Chandran, Dunlap, IL (US); Robert Richard Brimble, Edwards, IL (US)

(21) Appl. No.: 14/567,275

(22) Filed: Dec. 11, 2014

Related U.S. Application Data
(60) Provisional application No. 61/915,599, filed on Dec. 13, 2013.

(51) Int. Cl. A01G 25/16; G05B 15/02

(52) U.S. Cl. CPC A01G 25/16; G05B 15/02

(57) ABSTRACT

An automated garden monitoring and plant treatment system includes one or more sensors and programmable timers for the control of irrigation and other plant treatment devices that are connected to a server through wireless router that enables remote access using a smart phone or computing device. A sensor sends a measurement through a wireless router to the server. The user accesses the sensor information from the server from an Internet enabled device. The user can also assign programmable timer schedules, assign a sensor and/or programmable timer to a plant, manually turn on the programmable timer, or let the programmable timer activate whenever a predetermined level is reached. The computer or smart phone optionally receives data from the sensors and sends commands to the programmable timers using a local wireless data connection.

### CLAIM OF PRIORITY

This application claims priority to U.S. Provisional Application No. 61/915,599, which is entitled “SYSTEM AND METHOD FOR GARDEN MONITORING AND MANAGEMENT,” and was filed on Dec. 13, 2013, the entire contents of which are hereby incorporated by reference herein.

### TECHNICAL FIELD

This patent relates generally to the fields of horticulture, agriculture, and gardening and, more specifically, to systems and methods for the monitoring the conditions in the environment around plants and for plant treatment.

### BACKGROUND

Automation has become increasingly prevalent throughout residential and commercial buildings. Automation allows the consumer to control a variety of machines and systems from a variety of devices, most predominantly using a smart phone or other suitable electronic communication device. Building automation is currently being used to run lighting, smart energy, home entertainment, and security systems. These automation systems generally utilize independent networks that communicate with a wide variety of signal types including, but not limited to, radio frequency, Wi-Fi, Zigbee, and Z-wave.

### SUMMARY

There is a need for such automation for residential gardens and large industrial applications like green houses, horticultural farms, agricultural farms, golf courses, and the like. For example, many existing irrigation systems that are known to the art run on static timers and often waste water when activated during a rain storm or other precipitation. The existing systems do not adjust operation based on the measured conditions of the soil or other factors that affect the growth and health of plant life. Consequently, improved treatment systems for the monitoring and care of plants would be beneficial.

The system includes multiple sensors and programmable timers. The sensors, when placed into soil, take measurements of soil moisture, temperature, pH, and light intensity. Each sensor sends measurement data via Wi-Fi or another suitable wireless communication protocol to a server. In one embodiment, the server is communicatively connected to the sensors through a wide-area network (WAN) through a wireless access point that is within wireless communication range of the sensors. In another embodiment, the server is located on a local area network (LAN) with the sensors. In either embodiment, an end-user computing device, such as a smart phone, personal computer (PC), or other suitable computing device, accesses the server to enable a user to review sensor data and control the operation of one or more automated plant treatment systems including, for example, irrigation, fertilizer, temperature control, and light control systems.

The system implements a server, such as a web server or other networked information service, which is accessible through an end-user computing device, such as a smart phone or computer. The server enables the user to access the information sent by the sensors to the server. The user can monitor the information that has been sent, see trends, and determine any necessary actions for treatment of the plants based on the sensor data. In one configuration, each sensor is placed near a particular plant to monitor the particular plant. The plant monitoring information comes from a database designed that gives recommended levels of moisture, temperature, pH, and light intensity. Therefore, the program can classify the information from the sensors as bad, poor, or good based on these recommended levels. When the level of any of the measurements falls into the ‘bad’ category the user will receive an alert via text message or e-mail. Also, if the sensor is also assigned a programmable timer when the moisture level falls below the recommended level for that plant the timer will turn on, if it is above the level the programmable timer will turn off. The user can also turn the programmable timer on or off manually no matter what the reading of the sensor.

In one mode of operation, the system operates in an automated or “full function” mode. This mode uses sensors, programmable timers, and user input to drive the system. Another operating mode functions with programmable timers only while continuing to allow for user input. The second mode controls the programmable timer by allowing the user to set a scheduled start and stop time as well as starting and stopping the programmable timer manually.

The system is accessed externally, away from the home, through a smart phone or computer and any wireless digital network connection. The smart phone can also control the system directly when smart phone is within range of a local wireless access point or other equivalent wireless transceiver that is part of the system.

In one embodiment, a garden management system for use in both personal and commercial applications. The sensors accurately detect moisture, temperature, pH, and light intensity and these measurements are sent to a cloud based server for storage and analysis. The user can then access this information either locally or remotely with a provided software program and act on it.

The system performs actions to care for plants in the garden including measuring soil moisture and turning on/off a programmable timer to deliver water, measuring and distributing fertilizer, measuring and controlling light (in case of indoor and greenhouse applications), and measuring and controlling temperature (in case of indoor and greenhouse applications).

These actions can be completed by the user or the system could be setup in a way that it automatically controls the above mentioned parameters. This system also offers a larger selection of plant database with built-in plant requirements the user can readily use instead of having to know the specific requirements.

In one embodiment, a method for garden management has been developed. The method includes generating with at least one sensor placed in soil in a garden a plurality of measurements of at least one soil parameter during a first predetermined time period, operating at least one treatment system to control the growth of a plant in the garden during the first predetermined time period with reference to the plurality of measurements, storing a history of the operational parameters of the at least one operational system during the first predetermined time period in a memory, and operating the at least one treatment system with reference to the stored history of the operational parameters during a second predetermined time period and without reference to any measurements of soil parameters from the at least one sensor.

In another embodiment, a method of identification of plants for cultivation in a garden has been developed. The method includes generating with a sensor placed in soil in the garden a measurement of at least one soil parameter, transmitting with the sensor the measurement of the at least one soil parameter, identifying with the server at least one plant type for planting in the garden with reference to the measurement of the at least one soil parameter received from the sensor and a predetermined database of horticultural data for a plurality of plant types in association with soil parameters that promote growth of each plant type in the plurality of plant types, and transmitting with the server a recommendation to plant the identified at least one plant type to a computing device associated with the garden management system.

In another embodiment, a garden management system has been developed. The garden management system includes at least one sensor positioned in soil in a garden, the at least one sensor begin configured to generate a plurality of measurements of at least one soil parameter, at least one treatment system for the garden configured to treat a plant in the garden, a server communicatively connected to the at least one sensor and operatively connected to the at least one treatment system. The server is configured to receive the plurality of measurements of the at least one soil parameter from the at least one sensor during a first predetermined time period, operate the at least one treatment system to control the growth of a plant in the garden during the first predetermined time period with reference to the plurality of measurements, store a history of the operational parameters of the at least one operational system during the first predetermined time period in a memory, and operate the at least one treatment system with reference to the stored history of the operational parameters during a second predetermined time period and without reference to any measurements of soil parameters from the at least one sensor.

### BRIEF DESCRIPTION OF THE DRAWINGS

FIG. 1 is a schematic view of a system for monitoring and treating plants in a garden.

FIG. 2 is a block diagram of a process for monitoring and treating plants in a garden using the system of FIG. 1.

FIG. 3 is a block diagram of a process for measuring soil parameters in a garden and recommending types of plants to grow at the garden based on the soil parameters using the system of FIG. 1.

### DETAILED DESCRIPTION

For the purposes of promoting an understanding of the principles of the embodiments disclosed herein, reference is now be made to the drawings and descriptions in the following written specification. No limitation to the scope of the subject matter is intended by the references. The present patent also includes any alterations and modifications to the illustrated embodiments and includes further applications of the principles of the disclosed embodiments as would normally occur to one skilled in the art to which this patent pertains.

As used herein, the term “garden” refers to any plot of land or artificial installation that includes growing plant life. Examples of gardens include, but are not limited to, indoor or outdoor plots for growing fruits, vegetables, flowers, shrubs, trees, grass, and grains, green houses, horticultural farms, agricultural farms, hydroponic farms, golf courses, outdoor parks, nature preserves, and the like.

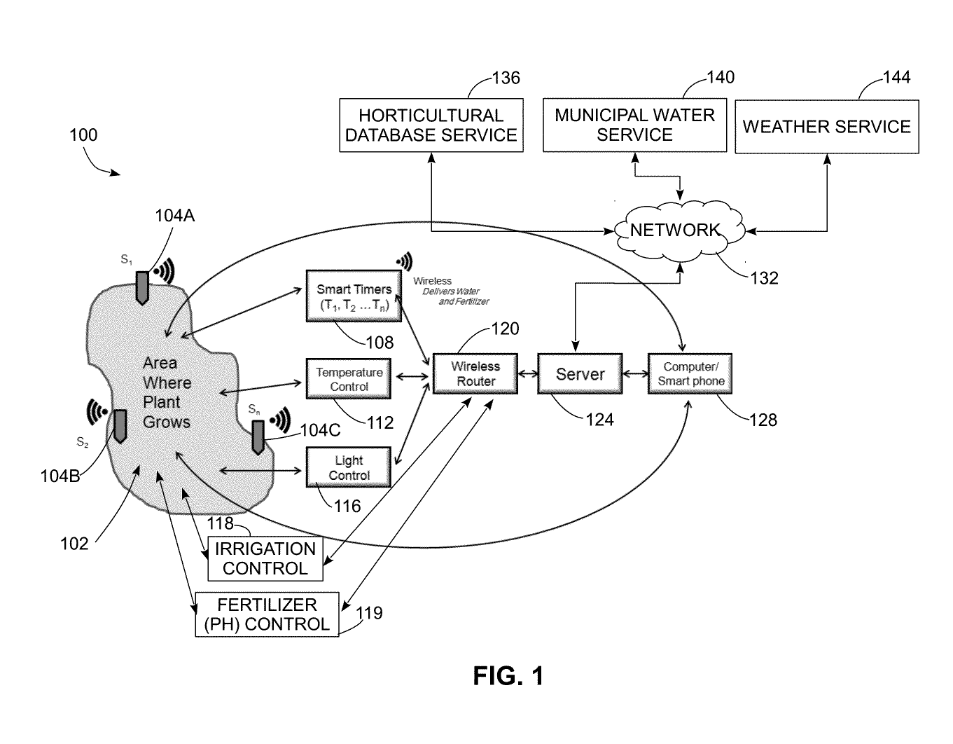

FIG. 1 depicts a garden management system 100. The system 100 includes sensors 104A-104C that are distributed around a garden 102, programmable (“smart”) timers 108 that control the operation of a temperature control system 112, a light control system 116, an irrigation control system 118, and a fertilizer control system 119. The irrigation system 118 includes watering or irrigation devices as well as misters or other devices that control humidity and moisture content in the garden 102. The fertilizer control system 119 controls the application of fertilizers as well as other chemical treatments including, for example, herbicides, pesticides, and soil treatments that adjust the pH level of soil. The temperature control system 112 is, for example, a climate control system in a greenhouse or other climate controlled garden environment. The light control 116 is, for example, an artificial light system that provides additional light to plants or a motorized shade system that controls the amount of sunlight that the plants receive. The temperature control system 112, light control system 116, irrigation control system 118, and fertilizer control system 119 are examples of garden treatment systems. More generally, a garden treatment system is any system that performs an activity to treat the garden or individual plants in the garden to promote the overall health of the plants. Different configurations of the system 100 include different combinations of the programmable timers 108 that control the temperature control systems 112, light control systems 116, irrigation control system 118, and fertilizer control system 119.

The sensors 104A-104C, programmable timers 108, temperature control system 112, and light control system 116 are communicatively connected via a wireless router 120. Each of the sensors 104A-104C is placed in soil within the garden 102 and measures at least one soil parameter. The soil parameter refers to a physical, chemical, or environmental property of the soil or environment in the garden 102 around each of the sensors 104A-104C. For example, the sensors 104A-104C generate soil parameter measurements of soil moisture levels, soil and air temperature levels, soil potential hydrogen (pH) levels, and sunlight levels that reach plants and the soil in the garden 102. In some embodiments, different sets of sensors sense one or a subset of the soil parameters while in other embodiments each sensor generates measurement of all the soil parameters. The wireless router 120 is, for example, a wireless access point (WAP) that implements the 802.11 family of wireless local area network (WLAN) protocols, although larger embodiments of the system 100 may include multiple access points or use wireless wide area network (WWAN) protocols to cover larger areas.

In the system 100, a server 124 receives data from the sensors 104A-104C and issues commands to operate the programmable timers 108, temperature control devices 112, and light control devices 116. As described above, in one embodiment the server 124 is communicatively connected to the wireless router 120 through a wide-area data network 132, such as the Internet, while in other embodiments the server 124 is part of a LAN that is associated with the wireless router 120. In the system 100, a user uses an end-user computing device 128, such as a smart phone or PC, to access information on the server 124 through a local or wide area network. In an alternative embodiment, the server 124 is incorporated into one or more of the programmable timers 108 that control the treatment systems in the garden maintenance system 100. In one embodiment, the computer 128 executes a web browser program application or another network client software program that enables the user to review sensor data that are stored on the server 124 and to issue commands for the system 100 that the server 124 relays to the system 100. In some embodiments, the end-user computing device 128 accesses the control devices 108, 112, and 116 directly through the wireless router 120 when access to the server 124 through the network 132 is unavailable.

The server 124 receives soil parameter data from the sensors 104A-104C to identify soil parameter conditions in different portions of the garden 102 and to identify information about larger regions of the garden 102. In one configuration, the server 124 identifies a drainage pattern for water and other fluids through the garden based on changes in the moisture content of the soil at the different locations in the garden 102 corresponding to the sensors 104A-104C. For example, if the sensors 104A and 104B measure a lager drop in moisture within a predetermined time period after the irrigation system 118 completes an irrigation operation while the sensor 104C registers an increase in moisture content even after the irrigation process is completed, the server 124 identifies that water in the garden 102 drains from the locations of the sensors 104A and 104B toward the location of the sensor 104C. The server 124 identifies the drainage information and use the drainage information to operate the irrigation system 118 and other treatment systems that use liquids, such as the fertilizer controller 119, in an efficient manner to ensure that different areas of the garden 102 have sufficient irrigation and that other areas of the garden 102 are not over-saturated with water and other fluids.

In the system 100, the server 124 retrieves data from a horticultural database service 136, municipal water service 140, and a weather service 144. The horticultural database service 136 is a predetermined database of horticultural data for a plurality of plant types in association with soil parameter values that promote growth of each plant type, and includes stored information about a wide range of plants, including plants that grow in the garden 102 and other types of plants that can grow in the garden 102 if the system 100 treats the garden 102 to change one or more soil parameters for the additional plant types. The server 124 receives configuration information from the end-user device 128 that associates one or more of the sensors 104A-104C with a particular plant or class of plants that grow near the corresponding sensors. The server 124 retrieves information about the optimal conditions for the identified plants from the horticultural database service 136. For example, the server 124 retrieves soil moisture, pH, temperature, and light exposure recommendations from the horticultural database service 136. If the sensor data indicate that the environment around the plants deviates from the recommended norms, then the server 124 generates an alert or other message for the end-user computing device 128. The user reviews the information about the plants and takes manual or automated action to return the conditions for the plants to the recommended range. While FIG. 1 depicts the horticultural database service 136 as a separate service that is connected to the server 124 through the network 132, in an alternative embodiment the server 124 stores the horticultural database data in a local memory storage device and accesses the horticultural data without requiring the network 132.

The municipal water service 140 is a web site or other online information service that is provided by a municipality or other entity that provides water for irrigation of the garden 102. The municipal water service 140 publishes information about restrictions on the use of water due to drought or other water shortages, and publishes price information for the usage of water. Examples of restrictions on water usage include both volume restrictions (e.g. a limit of 5 gallons of water for a 100 square foot area over any 24 hour period), timing restrictions (e.g. water for irrigation is only authorized for use between the hours of 4 AM and 6 AM and 8 PM and 10 PM), and combinations of volume and timing restrictions. The server 124 retrieves the information from the municipal water service and automatically modifies the programmable timers 108 to avoid irrigation of the garden 102 with the irrigation system 118 in a manner that violates the water usage restrictions. Additionally, the server 124 presents the water price information to the user to enable the user to set maximum price limits on the amount of water that the system 100 uses for irrigation during a predetermined period of time. For example, the user specifies a maximum expenditure for water during a one month period, and the server 124 uses the price information from the municipal water service 140 to adjust the irrigation schedules with the programmable timers 108 so that the water consumption rate of the system 100 does not exceed the maximum specified price ceiling for the month.

The weather service 144 is a web site or other online information service that provides current weather condition and weather prediction data for the geographic region that includes the garden 102. Outdoor gardens receive rain and other precipitation, and the server 124 retrieves the weather data to modify the operation of irrigation systems based on the precipitation patterns of the weather. While indoor gardens are isolated from some effects of the weather, the server 124 optionally retrieves weather data to identify if a greenhouse will receive full sunlight on a sunny day or require the activation of artificial lights on an overcast day.

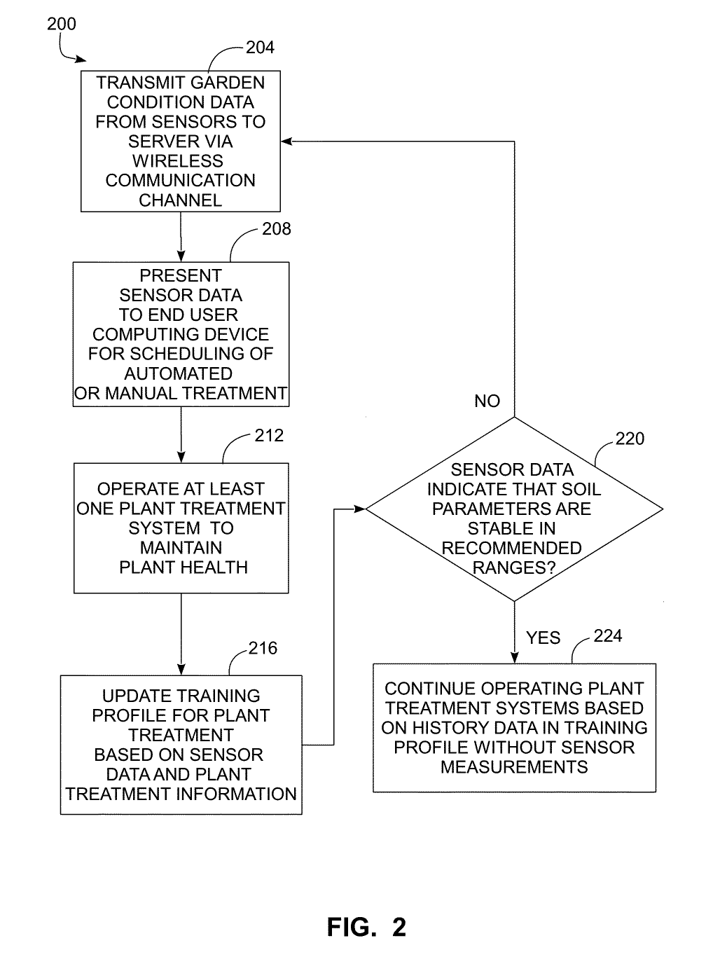

FIG. 2 depicts a block diagram of a process 200 for operating the system 100 in a training mode to maintain the health of plants in a garden. In the description below, a reference to the process 200 performing an action or function refers to the execution of stored program instructions by one or more digital processing devices to perform the function or action in conjunction with one or more components in the system 100.

Process 200 continues as the server optionally generates a presentation of recorded sensors data to the end-user computing device 128 for scheduling of automated garden plant treatment devices or manual garden maintenance (block 208). In the system 100, the server 124 displays records of the data from each of the sensors 104A-104C that is associated with an individual plant in the garden 102. In addition to displaying the sensor data using graphs or tables, the server 124 retrieves information about the recommended conditions for the plant from the horticultural database service 136. The server 124 compares the present sensor data for the plant to the recommendations for the plant environment from the horticultural database 136, and presents a summary or alerts about the condition of the plant to the user. For example, the server 124 retrieves recommended range of soil moisture levels for the soil around a plant from the horticultural database 136. The server 124 presents a status message to the end-user computing device 128 indicating if the solid moisture content is within the recommended range (e.g. “good”) or if the soil moisture content deviates from the desired range (e.g. “needs watering,” or “soil saturated, do not water”).

Process 200 continues as the server 124 operates one or more plant treatment systems with reference to the sensor data to maintain the plant health (block 212). As described above, the server 124 optionally schedules the operation of irrigation system 118, fertilizer system 119, thermostats 112, light control devices 116, and other plant treatment devices in the system 100 using the programmable timers 108. The end-user computing device 128 presents a scheduling interface, such as a calendar or other time planning interface, to enable the user to specify the treatment schedules for the system 100. In another configuration, the server 124 generates a treatment schedule in an automated manner based on the sensor data from the environment around the plant and the recommended conditions for the plant from the horticultural database 136. The system 100 can use the automated schedule or present the automated schedule to the user to enable the user to modify the schedule.

Process 200 begins as the sensors 104A-104C transmit recorded garden condition data to the server 124 through a wireless communication channel, such as a point to point wireless channel or through the wireless access point 120 and the network 132 (block 204). As described above, the sensors 104A-104C record various data about the environment in the garden 102 including, but not limited to, soil moisture content, air humidity, air and soil temperature, light exposure, soil pH, and the like. During process 200, at least one sensor is associated with a selected plant in the garden 102. The sensor is positioned near the plant to collect environmental data pertaining to the plant, and the user enters identifying information about the plant in association with the sensor with the end-user computing device 128. As described in more detail below, in some configurations multiple sensors that are located in different portions of the garden generate soil parameter measurements for the different locations in the garden to enable the server to identify information about the garden. For example, the server 124 analyzes changes in the moisture content of soil at different locations in the garden over time to identify drainage patterns of water through the garden. The server 124 uses the drainage information to control the time and volume of water for irrigation and the use of other chemicals that flow through the garden with water drainage.

After manual or automatic updates to the care schedule for the plant, the server 124 updates training data associated with the plant and the sensor (block 216). The training data include a history of schedules for the programmable timers 108 and settings for the system 100 to care for the plant, and a history of sensor data for the plant. In one embodiment, the server 124 stores the history data in a memory, such as a volatile or non-volatile digital data storage device. As described above, the server 124 receives the horticultural data including the recommended ranges for various parameters in the environment around the plant, such as the soil parameters including soil moisture content, pH, temperature, and the intensity level of light that reaches the soil. The training profile includes a history of the settings for operating the system 100 to care for the plant, and the resulting environmental data from the sensor that records information about the plant.

Process 200 continues as described above with reference to the processing in blocks 204-216 to update the schedules for plant treatment and training profiles while the sensor data indicate that the environment around the plant is not being maintained within the recommended ranges in a stable manner (block 220). For example, the server 124 and user make multiple changes to the watering schedule for a plant if the measured soil moisture content parameter data from the sensors 104A-104C indicate that the selected schedules do not maintain the soil moisture content within the recommended range over the course of a week.

Process 200 continues until the sensor data indicate that the planned schedule of treatment to operate the plant treatment systems and maintain the soil parameters for the plant around the plant in the recommended ranges in a stable manner (block 220). In the embodiment of FIG. 2, the system 100 continues plant treatment using the existing plant treatment profile and server 124 sends a message to the end-user computing device 128 indicating that the sensor can be moved (block 224). In this embodiment, the sensors 104A-104C can be moved to different locations in the garden 102 and be configured to monitor the environment around different types of plants. Once the server 124 identifies that the scheduled care profile for the plant maintains the conditions around the plant within the recommended ranges, the sensor can be moved to monitor a different plant. Thus, the system 100 is configured to use a comparatively limited number of sensors to monitor a larger number of plants in a garden. In another embodiment, the sensor continues to monitor the environment around the plant and the server 124 generates an alert if the sensor data indicate that the environment around the plant deviates from the recommended ranges.

In the system 100, the server 124 optionally receives water restriction data from the municipal water service 140. During both the training portion and post-training portion of the process 200, the server 124 operates the irrigation system 118 to ensure that the volume and time of day of consumed water remain within any limitations from the municipal water service 140.

In some embodiments, the server 124 uses the history data from the training profile to generate estimates for one or more soil parameter measurements even when the sensors 104A-104C are not present to transmit any soil parameter measurements. In one configuration, the server 124 identifies measured moisture content levels from the sensors 104A-104C in conjunction with precipitation levels in weather reports that the server 124 receives from the weather service 144. During operation without the direct measurements from the sensors, the server 124 retrieves additional weather reports from the weather service 144. The server 124 identifies if a precipitation level in the newly retrieved weather report corresponds to a precipitation level in the stored history data in the training profile. The server 124 then identifies the stored moisture level measurements that are associated with the precipitation level, and the server 124 generates an estimate of the moisture level based on the stored moisture level data. The server 124 then operates the irrigation system 118 using one or more of the programmable timers 108 to adjust the amount of water flow to maintain the level of moisture in the garden 102 based on the estimated moisture level parameter. For example, the server 124 delays operation of the irrigation system 118 in response to identifying an estimated moisture content of the soil that exceeds the predetermined threshold for plants in the garden 102 in response to a weather report that indicates heavy precipitation and a correspondingly high moisture content in the soil from the history data in the training profile.

The server 124 also uses weather report information to generate estimates of the level of sunlight that reaches soil in the garden 102 to control the level of artificial light that is generated by the light control system 116. The server 124 receives weather reports including reports of cloud cover and relative sunlight during daylight periods during the training process. The sensors 104A-104C also detect sunlight levels and the server 124 generates history data in the training profile that associates the measured sunlight parameter data with the cloud cover and sunlight levels in the weather reports. After the system 100 enters the second time period without the soil parameter data from the sensors 104A-104C, the server 104 generates estimates of the sunlight parameter using newly received weather reports from the weather service 144 and the history data of observed light levels in the training profile. The server 124 controls the operation of the light control system 116 using the estimated light levels to maintain a level of light for the plants in the garden 102 during daylight hours.

In the system 100, the server 124 is configured to receive soil parameter data from the sensors 104A-104C and generate recommendations for plant types that can be planted in the garden 102. In some configurations, the server 124 receives a request for another type of plant that is not one of the recommended plant types from the user computing device 128. The server 124 identifies required soil and environmental parameters for the non-recommended plant type and generates a recommendation of treatments for the garden 102 that would enable the plant to grow in the garden 102. In some instances, the server 124 operates one or more of the treatment systems with the programmable timers 108 including the temperature control system 112, light control system 116, irrigation control system 118, and fertilizer control system 119.

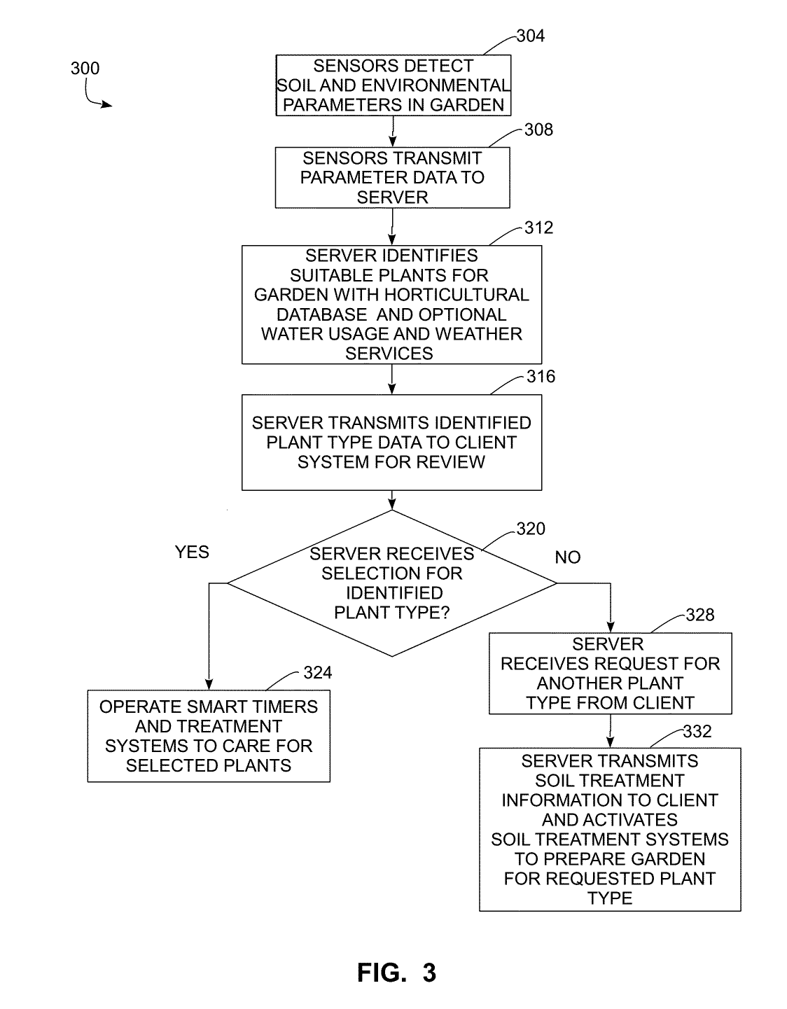

FIG. 3 depicts a process 300 for operation of the system 100 to recommend plant types for cultivation in the garden 102 and for optional treatment of the garden 102 to accommodate different plant types. In the description below, a reference to the process 300 performing a function or action refers to the operation of a computing device, such as the server 124, to execute programmed instructions to perform the function or action in association with other components in the garden management system 100.

Process 300 begins as the sensors 104A-104C detect soil parameters and other environmental parameters at different locations in the garden 102 (block 304). As described above, the sensors 104A-104C measure various soil parameters including, but not necessarily limited to, at least one of a soil moisture content level, soil temperature level, pH level, and light level parameter. The sensors 104A-104C transmit the measurements to the server 124 through the wireless router 120 in the illustrative embodiment of FIG. 1, or through another wireless network or in a point to point wireless communication channel in alternative embodiments (block 308). In some configurations, the system 100 performs the process 300 using a single set of soil parameter measurement data from at least one of the sensors 104A-104C, while in other embodiments the sensors 104A-104C generate a plurality of measurements over a predetermined time period (e.g. one day, one week, one month, etc.) and transmit multiple sets of soil parameter measurements to the server 124.

Process 300 continues as the server 124 identifies one or more plant types that are suitable for cultivation in the garden 102 (block 312). The term “plant type” refers to specific species and varieties of a plant or to broader categories of plants that are suitable for cultivation in the garden 102. The server 124 identifies the suitable plant types using the horticultural database service 136 to identify plants that are suitable for growth under the soil and environmental condition that the server 124 identifies in the soil parameter data received from the sensors 104A-104C.

In some configurations, the server 124 also identifies suitable plant types with reference to water usage restriction data from the municipal water service 140 and weather forecast information from the weather service 144. In some instances, the server 124 eliminates a plant type from being considered suitable for cultivation in the garden 102 if the irrigation requirements for the plant exceed volume or time of day restrictions on the use of water for irrigation of the garden 102. The server 124 also eliminates some plant types from consideration if the long-term weather forecasts indicate that the general climate for an outdoor garden is not amenable to growing the plant. For example, the sensor data for soil parameter measurements in a temperate climate may indicate hot and dry conditions during a portion of the summer months. However, the server 124 receives long term weather information for the garden 102 indicating that cold and wet conditions occur in winter, so certain types of plant, such as cactus, may not be suitable for cultivation in the garden 102 even if the soil parameters for the garden 102 are suitable for cactus growth during portions of the year.

In some configurations, the server 124 identifies suitable plants based on multiple sets of soil parameter measurements from the sensors 104A-104C that are generated over a predetermined time period. The server 124 identifies one or more statistics for the soil parameter measurements such as an average, variance, and maximum and minimum range of the at least one soil parameter. The server 124 uses the identified statistics for the soil parameters to identify suitable plant types. The statistics corresponding to multiple soil parameter measurements enable the system 100 to identify suitable plant types for the garden 102 based on long-term measurements of the soil parameters in the garden 102 instead of from a single set of soil parameters that are measured over a comparatively short time period.

In some instances, the server 124 identifies plant types that are suitable for growth in I in only portions of the garden 102 based on the soil parameter data received from the sensors 104A-104C. For example, as described above the server 124 identifies drainage patters in the garden 102 with reference to variations in the soil moisture level measurements from the sensors 104A-104C. A plant type that requires a higher moisture level may be suitable for growth in the region of the garden near the sensor 104C that corresponds to a region where moisture tends to accumulate to a greater degree than in the regions near the sensors 104A and 104B where the soil does not retain sufficient moisture for cultivation of the plant type. The server 124 identifies drainage patterns and other characteristics of the garden 102 to select suitable plant types for cultivation in all or a region of the garden 102.

Process 300 continues as the server 124 transmits data corresponding to the identified plant type to a client computing device, such as the smart phone or computer 128, to enable a user to review one or more plant types that are suitable for cultivation in the garden 102 (block 316). In some embodiment of the process 300, the server 124 receives a request from the client computing device 128 and identifies the suitable plant types for the garden 102 in response to the request. The data corresponding to the suitable plant types includes, for example, common and scientific names for specific plant species or broader varieties of plants, photographic images or illustrations of representative plants for the plant types, planting and care recommendations for each plant type, and the like.

In some instances, the client computing device 128 transmits a selection of one of the identified plant types to the server 124 to indicate that a user is planting the selected plant type in the garden 102 (block 320). The server 124 operates the smart timers 108 and other treatment systems in the system 100 to maintain the soil parameters for all or a portion of the garden 102 in a range that accommodates the selected plant type (block 324). In some instance, if the garden 102 already has soil parameters that are suitable for cultivation of the selected plant, the server 124 monitors and maintains the soil parameters in the garden 102 in a similar manner to the process 200 that is described above in conjunction with FIG. 2.

In some instances, the user of the client computing device 128 selects a plant type for cultivation in the garden 102 other than any of the identified plant types (block 320). The server 124 receives the request for the other plant type and identifies the soil parameters that are recommended for cultivation of the selected plant type in the horticultural database 136 (block 328). For example, in one embodiment the server 124 receives a request for a plant type that thrives in acidic soil (pH less than 7) but the server 124 has received soil parameter data from the sensors 104A-104C indicating that the soil in the garden 102 has a basic pH (pH>7).

The server 124 identifies the recommended soil parameters for the requested plant type in the horticultural database 136 and generates a recommendation for a treatment that adjusts the soil parameters of the garden 102 to accommodate the requested plant type (block 332). For example, the server 124 identifies a recommended soil pH range for the requested plant type in the horticultural database 136 and transmits a recommendation to the client computing device 128 for a chemical soil treatment that reduces the pH level to an acceptable level for cultivation of the requested plant. In the embodiment of FIG. 1, the server 124 also operates the fertilizer system 119 to apply a chemical treatment to all or a portion of the garden 102 to reduce the pH level until the garden 102 can accommodate the selected plant type. The server 124 receives soil parameter measurement data from one or more of the sensors 104A-104C to monitor the pH level to ensure that the requested plant type from the user can be cultivated in the soil of the garden 102.

In another instance of the process 300, the server 124 receives a request for a type of plant that requires a higher soil moisture level than is present in the soil of the garden 102 as measured by the sensors 104A-104C. The server 124 operates one or more of the programmable timers 108 to increase a flow of water from the irrigation system 118 to increase the moisture level in the soil until the soil can accommodate the requested plant type.

Additional features of the garden management systems described above are set forth below. The system 100 includes a programmable timer that enables users to have complete flexibility in setting up watering schedules and will have unlimited watering schedules. The programmable timer has the capability to postpone watering if it is going to rain. This is done by connecting to the online weather service. The programmable timer has the capability to connect to local municipalities watering division and will gain information about any watering restrictions. The timer automatically adjusts watering schedules to accommodate the restrictions. The garden management system informs the user of the water consumption for gardening and the associated costs. The system is reconfigurable to limit the volume of water used to limit a total cost of watering the garden over a predetermined time period.

The garden management system includes sensors that produce measurements of soil parameters including soil moisture, temperature, pH, and light conditions. The sensors transmit the soil parameter data to a server over a wireless communication channel. In some embodiments, the server is embedded with the programmable timer for local communication with the sensors, while in other embodiments the sensors transmit the soil parameter measurement data through a local area network (LAN) or wide area network (WAN) to a remote server. The garden management system implements a training or “learning” process. This is enabled by storing the raw data over a period of time and using that data later on without the sensor being present. For example, a sensor can be placed in a potted plant for period of time and the data (moisture, pH, Temperature and Light) is recorded until the plant is maintained healthy and the sensor is removed. This recorded data can be used for future maintenance of the plant without the sensor. The programmable timer actuates and delivers water and fertilizer based on readings from the sensor.

In different operating modes the garden management system provides parameter measurements from the sensors to a user, provides automation of watering and other garden treatments without the use of sensors, or uses the sensor data to control the automation of watering and other garden treatments for the garden. Treatment systems for the garden management system include, but are not limited to, irrigation systems, fertilization systems, herbicide and pesticide distribution systems, and programmable lighting and thermostat system. The garden management system incorporates or retrieves data from a database of horticultural information for multiple plant types that are present in the garden and additional plant types that may be planted in the garden. The system controls treatment of the garden based on the horticultural database information to maintain the health of plants that are present in the garden or treat the garden to be suitable for additional types of plants. In the event of interruption of network access, the programmable timers and sensors can communicate using a point to point wireless communication system such as a Bluetooth or Zigbee wireless communication system. The garden management system includes network connectivity to external sources to receive weather report information, and water consumption limit data including maximum water volume consumption limits, time of day watering restrictions, and water price information.

It will be appreciated that variants of the above-disclosed and other features and functions, or alternatives thereof, may be desirably combined into many other different systems, applications or methods. Various presently unforeseen or unanticipated alternatives, modifications, variations or improvements may be subsequently made by those skilled in the art that are also intended to be encompassed by the following claims.

What is claimed is:

1. A method for garden management comprising:
generating with at least one sensor placed in soil in a garden a plurality of measurements of at least one soil parameter during a first predetermined time period;
operating at least one treatment system to control the growth of a plant in the garden during the first predetermined time period with reference to the plurality of measurements;
storing a history of the operational parameters of the at least one operational system during the first predetermined time period in a memory; and
operating the at least one treatment system with reference to the stored history of the operational parameters during a second predetermined time period and without reference to any measurements of soil parameters from the at least one sensor.

2. The method of claim 1, the generation of the plurality of measurements of the at least one soil parameter further comprising:
generating with the at least one sensor the plurality of measurements of at least one of a moisture content level of the soil, a potential hydrogen (pH) level of the soil, a temperature level of the soil, and an intensity level of light that reaches the soil.

3. The method of claim 1 further comprising:
receiving with a server water usage restriction data corresponding to the garden;
identifying with the server a volume limit of water to be applied to the garden during irrigation with reference to the water usage restriction data;
operating with the server an irrigation system during the first predetermined time period to irrigate the garden with a volume of water that is less than a limit identified in the water usage restriction; and
continuing operation with the server of the irrigation system during the second predetermined time period to irrigate the garden with the volume of water that is less than the limit identified in the water usage restriction data.

4. The method of claim 1 further comprising:
receiving with a server water usage restriction data corresponding to the garden;
identifying with the server a time of day limitation for when irrigation is permitted to be applied to the garden with reference to the water usage restriction data;
operating with the server an irrigation system during the first predetermined time period to irrigate the garden during only a time of day that is within the time of day limitation; and
continuing operation with the server of the irrigation system during the second predetermined time period to irrigate the garden during only a time of day that is within the time of day limitation.

5. The method of claim 1 further comprising:
receiving with a server a first weather report indicating precipitation in a geographic region including the garden during the first predetermined time period;
identifying with the server a first level of precipitation received by the garden with reference to the first weather report;
storing with the server an association between a moisture level measurement of the soil from the at least one sensor and the first level of precipitation during the first predetermined time period in a memory;
receiving with the server a second weather report indicating precipitation during the second predetermined time period in the geographic region including the garden;
identifying with the server a second level of precipitation received by the garden with reference to the second weather report; and
generating with the server an estimated moisture level of the soil during the second predetermine time period with reference to the association stored in the memory in response to the second precipitation level corresponding to the first precipitation level; and
operating with the server an irrigation system to control a level of irrigation in the garden with reference to the estimated moisture level of the soil during the second predetermined time period.

6. The method of claim 5, the operation of the irrigation system further comprising:
operating with the server the irrigation system to delay operation of the irrigation system in response to the estimated moisture level of the soil being above a predetermined threshold.

7. The method of claim 1 further comprising:
receiving with a server a first weather report indicating a level of cloud cover during a daylight portion of the first predetermined time period in a geographic region including the garden;
identifying with the server a first level of sunlight received by the garden with reference to the first weather report;
storing with the server an association between a level of light received by the soil from the at least one sensor and the first level of cloud cover during the daylight portion of the first predetermined time period in a memory;
receiving with the server a second weather report indicating a level of cloud cover during a daytime portion of the second predetermined time period in the geographic region including the garden;
identifying with the server a second level of sunlight received by the garden with reference to the second weather report; and
generating with the server an estimated level of sunlight received by the garden during the daytime portion of the second predetermine time period with reference to the association stored in the memory in response to the second level of sunlight corresponding to the first level of sunlight; and
operating with the server a lighting system to control a level of light in the garden with reference to the estimated level of sunlight during the daylight portion of the second predetermined time period.

8. A method of identification of plants for planting in a garden comprising:
generating with a sensor placed in soil in the garden a measurement of at least one soil parameter;
transmitting with the sensor the measurement of the at least one soil parameter;
identifying with the server at least one plant type for planting in the garden with reference to the measurement of the at least one soil parameter received from the sensor and a predetermined database of horticultural data for a plurality of plant types in association with soil parameters that promote growth of each plant type in the plurality of plant types; and
transmitting with the server a recommendation to plant the identified at least one plant type to a computing device associated with the garden management system.

9. The method of claim 8, the measurement of the at least one soil parameter further comprising:
measuring with the sensor at least one of a moisture content level of the soil, a potential hydrogen (pH) level of the soil, a temperature level of the soil, and an intensity level of light that reaches the soil.

10. The method of claim 8 further comprising:
generating with the sensor placed in soil in the garden a plurality of measurements of the at least one soil parameter during a predetermined time period;
transmitting with the sensor the plurality of measurements of the at least one soil parameter to the server; and
identifying with the server the at least one plant type with reference to one of an average, variance, and maximum and minimum range of the at least one soil parameter.

11. The method of claim 8 further comprising:
generating with a plurality of sensors placed in soil in a plurality of locations in the garden a plurality of soil moisture content measurements in the garden;
transmitting with the plurality of sensors the plurality of soil moisture content measurements to the server;
identifying with the server a drainage pattern of water in the garden with reference to the plurality of soil moisture content measurements; and
identifying with the server the at least one plant type for planting in the garden with reference to the drainage pattern.

12. The method of claim 8 further comprising;
receiving with the server water usage restriction data corresponding to the garden; and
identifying with the server only plants that can be grown in the garden within the water usage restrictions with reference to the horticultural database and the water usage restriction data.

13. The method of claim 8 further comprising:
receiving with the server a request for another plant type to plant in the garden other than the at least one identified plant type;
identifying with the server a measurement for at least one soil parameter for the other plant type with reference to the predetermined database of horticultural data; and
generating a recommendation to treat the soil for the at least one soil parameter to enable the garden to grow the other plant type with reference to the at least one soil parameter for the other plant type.

14. The method of claim 13 further comprising:
operating with the server an irrigation system to irrigate garden in response to identifying a soil parameter for the other plant type indicating a higher soil moisture content than is present in a soil moisture parameter measurement received from the at least one sensor.

15. A garden management system comprising:
at least one sensor positioned in soil in a garden, the at least one sensor begin configured to generate a plurality of measurements of at least one soil parameter;
at least one treatment system for the garden configured to treat a plant in the garden;
a server communicatively connected to the at least one sensor and operatively connected to the at least one treatment system, the server being configured to:
receive the plurality of measurements of the at least one soil parameter from the at least one sensor during a first predetermined time period;
operate the at least one treatment system to control the growth of a plant in the garden during the first predetermined time period with reference to the plurality of measurements;
store a history of the operational parameters of the at least one operational system during the first predetermined time period in a memory; and
operate the at least one treatment system with reference to the stored history of the operational parameters during a second predetermined time period and without reference to any measurements of soil parameters from the at least one sensor.

16. The garden management system of claim 15, the at least one treatment system further comprising:
a plurality of programmable timers; and
the server being incorporated into a first programmable timer in the plurality of programmable timers.

17. The garden management system of claim 16, the server being configured to
communicate with the at least one sensor and at least a second programmable timer in the plurality of programmable timers using a point to point wireless communication system.

18. The garden management system of claim 16, the server being further configured to:
identify at least one plant type for planting in the garden with reference to the measurement of the at least one soil parameter received from the at least one sensor and a predetermined database of horticultural data for a plurality of plant types in association with soil parameters that promote growth of each plant type in the plurality of plant types; and
transmitting with the server a recommendation to plant the identified at least one plant type to a computing device associated with the garden management system.

19. The garden management system of claim 15, the at least one sensor being further configured to:
measure at least one of a moisture content level of the soil, a potential hydrogen (pH) level of the soil, a temperature level of the soil, and an intensity level of light that reaches the soil.

20. The garden management system of claim 15, the at least one treatment system further comprising:
an irrigation system configured to irrigate the garden.
